(19) United States
(12) Patent Application Publication
(10) Pub. No.: US 2010/0085328 A1
(43) Pub. Date: Apr. 8, 2010

(54) Touch-Sensitive Display Device And Method

(75) Inventor: Bradley Suggs, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: HEWLETT-PACKARD DEVELOPMENT COMPANY, L.P., Houston, TX (US)

(21) Appl. No.: 12/247,784

(22) Filed: Oct. 8, 2008

(51) Int. Cl. G06F 3/042

(52) U.S. Cl. 345/175

(57) ABSTRACT

Apparatus for providing a touch-sensitive display are provided. A touch-sensitive display apparatus can include a first layer comprising a plurality of emitters disposed thereupon and a second layer comprising a screen for the display of images visible to the human eye. A first portion of the emitters can emit electromagnetic radiation at one or more first wavelengths invisible to the human eye. The electromagnetic radiation at the first wavelength can be partially or completely transmissible through the second layer. A user can dispose an object proximate to the second layer, causing the reflection of all or a portion of the electromagnetic radiation therefrom. The remaining portion of the emitters can absorb all or a portion of the reflected electromagnetic radiation at the first frequency.

### BACKGROUND OF THE INVENTION

1. Field of the Invention

Embodiments of the present invention generally relate to systems and methods for providing a touch-sensitive display. More particularly, embodiments of the present invention relate to systems and methods for providing a touch-sensitive display using infrared light emitting diodes.

2. Description of the Related Art

This section is intended to introduce the reader to various aspects of art which may be related to one or more aspects of the present invention as described and claimed below. This discussion is believed helpful in providing the reader with background information, thereby facilitating a better understanding of various aspects of the present invention. Accordingly, it should be understood by the reader that the provided information should be read in this light and not as an admission of prior art.

Many electronic devices include displays for presenting visual information. The size of the display can range in size from a watch, to a large-scale bulletin board. In years past, displays were traditionally manufactured using cathode ray tube (“CRT”) technology. As CRT size increased, the weight and bulk of the displays grew disproportionately. More recent developments and economies in thin-screen, non-CRT, technology, such as liquid crystal displays (“LCD”), plasma displays, and light emitting diode (LED) displays, have made such displays, in sizes ranging from small (e.g. less than two inches) to very large (e.g. greater than 65 inches) both economically reasonable and physically practical for everyday use. These non-CRT displays can be used with equal effectiveness as television type displays or computer monitors.

To increase utility and functionality, non-CRT computer displays can be combined with one or more touch-sensitive input technologies to provide an interactive display. Interactive displays provide enhanced functionality as computer displays for their ability to both display output and receive input from a user. Multiple touch-sensitive input technologies have been employed to provide a display that recognizes pressure applied by an object such as a fingertip. Touch-sensitive displays can be used to reduce or eliminate the need for the user to interact with a variety of computer input devices such as a mouse, trackball, touchpad, and/or keyboard.

With the decreasing cost of non-CRT displays and the increasing demand for touch sensitive displays, there is a need therefore, for cost effective non-CRT displays incorporating touch-sensitive technology.

### SUMMARY OF THE INVENTION

Apparatus for providing a touch-sensitive display are provided. A touch-sensitive display apparatus can include a first layer comprising a plurality of emitters disposed thereupon and a second layer comprising a screen for the display of images visible to the human eye. A first portion of the emitters can emit electromagnetic radiation at one or more first wavelengths invisible to the human eye. The electromagnetic radiation at the first wavelength can be partially or completely transmissible through the second layer. A user can dispose an object proximate to the second layer, causing the reflection of all or a portion of the electromagnetic radiation therefrom. The remaining portion of the emitters can absorb all or a portion of the reflected electromagnetic radiation at the first frequency.

Methods for providing a touch-sensitive display are also provided. A plurality of emitters can be disposed in a first layer. A second layer, for the projection of images visible to the human eye can be disposed between the first layer and a user. A first portion of the emitters can emit electromagnetic radiation, partially or completely transmissible through the second layer and at a first frequency invisible to the human eye. When the user passes an object across the second layer, all or a portion of the electromagnetic radiation at the first wavelength can be reflected from the object, back to the first layer, where a second portion of the emitters can absorb the reflected electromagnetic radiation and generate one or more signals proportionate thereto. The one or more signals can be used as an input to one or more computing devices.

### BRIEF DESCRIPTION OF THE DRAWINGS

A more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

Advantages of one or more disclosed embodiments may become apparent upon reading the following detailed description and upon reference to the drawings in which:

FIG. 1 depicts a schematic orthogonal view of an illustrative touch-sensitive display, according to one or more embodiments described;

FIG. 2 depicts a schematic elevation view of the illustrative touch-sensitive display depicted in FIG. 1, according to one or more embodiments described;

FIG. 3A depicts a schematic view of an illustrative emitter array, according to one or more embodiments described;

FIG. 3B depicts another schematic view of the illustrative emitter array depicted in FIG. 3A, according to one or more embodiments described;

FIG. 3C depicts a schematic view of another illustrative emitter array, according to one or more embodiments described;

FIG. 3D depicts another schematic view of the illustrative emitter array depicted in FIG. 3C, according to one or more embodiments described;

FIG. 3E depicts a schematic view of yet another illustrative emitter array, according to one or more embodiments described;

FIG. 3F depicts another schematic view of the illustrative emitter array depicted in FIG. 3E, according to one or more embodiments described;

FIG. 4 depicts a system including an exemplary touch-sensitive display, according to one or more embodiments described;

FIG. 5 depicts an illustrative method for providing a touch-sensitive display, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

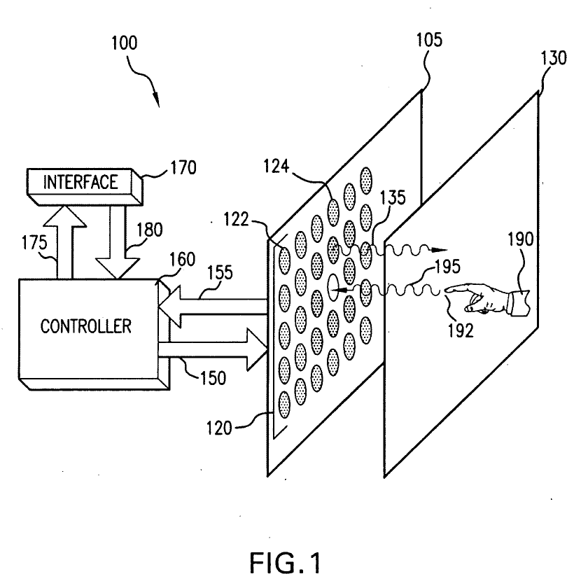

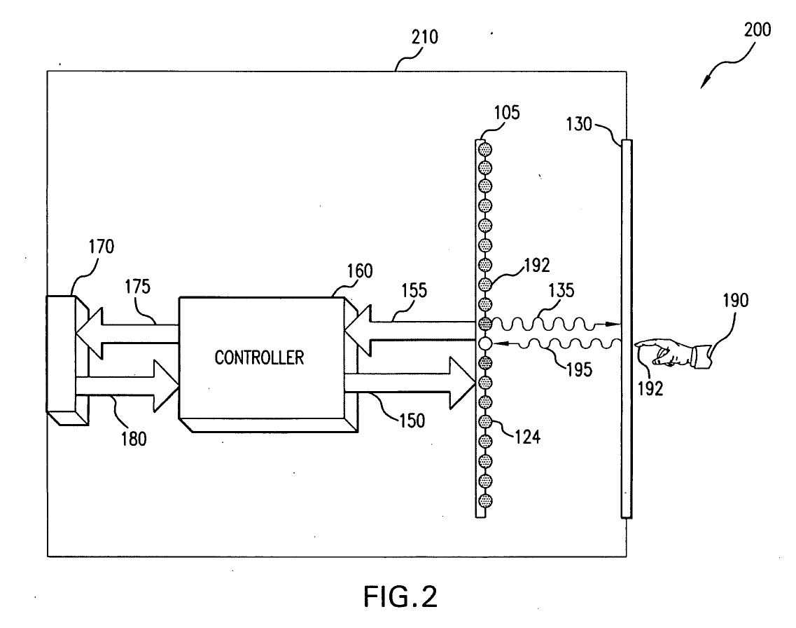

FIG. 1 depicts a schematic orthogonal view of an illustrative touch-sensitive display 100, according to one or more embodiments. FIG. 2 depicts a schematic elevation view of the illustrative touch-sensitive display 100 depicted in FIG. 1, according to one or more embodiments. The illustrative touch-sensitive display apparatus depicted in FIGS. 1 and 2 can include a first layer 105 having a plurality of emitters 120 disposed thereupon. The illustrative touch-sensitive display apparatus 100 depicted in FIGS. 1 and 2 can also include a second layer 130 suitable for the display of images visible to the human eye. Additionally, the touch sensitive display can also include one or more controllers 160 and interfaces 170.

The plurality of emitters 120 can be disposed in, on, or about a first, or front, side of the first layer 105. Although the first layer 105 is depicted as having a planar configuration in FIG. 1, the first layer 105 can have any shape or configuration. For example, the first layer 105 can be curved along one or more axes to form a horizontally or vertically curved surface about a single axis or a convex curved or concave curved surface about two or more axes. The individual emitters forming the plurality of emitters 120 can be disposed in, on, or about the first layer 105 in a regular or random arrangement. In one or more embodiments, a regular arrangement can be used, with the emitters 120 and 125 disposed in a grid or matrix using a square pitch, rectangular pitch, triangular pitch, or any other series or configuration having one or more repeating patterns. In one or more specific embodiments, the plurality of emitters 120 can be disposed in a regular, square, arrangement having an intra-emitter spacing along a first axis of about 0.8 mm ( 1/32 in.) or less; about 3.2 mm (⅛ in.) or less; about 6.4 mm (¼ in.) or less; about 9.5 mm (⅜ in.) or less; about 12.7 mm (½ in.) or less; about 15.9 mm (⅝ in.) or less; about 19.1 mm (¾ in.) or less; or about 22.2 mm (⅞ in.) or less. In one or more specific embodiments, the plurality of emitters 120 can be disposed in a regular, square, arrangement having an intra-emitter spacing along a second axis, complementary to the first axis, of about 0.8 mm ( 1/32 in.) or less; about 3.2 mm (⅛ in.) or less; about 6.4 mm (¼ in.) or less; about 9.5 mm (⅜ in.) or less; about 12.7 mm (½ in.) or less; about 15.9 mm (⅝ in.) or less; about 19.1 mm (¾ in.) or less; or about 22.2 mm (⅞ in.) or less.

The plurality of emitters 120 can be any device, system or combination of systems and/or devices suitable for or capable of the discharge, generation, emission, or radiation of electromagnetic energy at one or more first wavelengths when power is applied to the plurality of emitters 120. In one or more specific embodiments, the plurality of emitters 120 can be equally or unequally grouped, allocated, distributed, allotted, or apportioned into a powered first portion (hereinafter “transmitters”) 122, and an unpowered second portion (hereinafter “receivers”) 124. The discharge, generation, emission, or radiation of electromagnetic energy can be provided by the transmitters 124. The electromagnetic energy at the one or more first wavelengths can be visible or invisible to the human eye.

In one or more embodiments, the one or more first wavelengths can be in the ultraviolet (“UV”) portion of the electromagnetic spectrum. In one or more specific embodiments, the one or more first wavelengths can be in the ultraviolet A (“UVA”) spectrum, having a wavelength of from about 315 nm to about 400 nm. In one or more embodiments, the one or more first wavelengths can be in the infrared (“IR”) portion of the electromagnetic spectrum. In one or more specific embodiments, the one or more first wavelengths can be in the infrared (“IR”) spectrum, having a wavelength of from about 800 nm to about 1,000 nm; about 830 nm to about 970 nm; or about 850 nm to about 940 nm. In one or more specific embodiments, the plurality of emitters can include, but are not limited to a plurality IR transmitters emitting electromagnetic energy at one or more wavelengths of from about 840 to about 940 nm.

The plurality of emitters 120 can include one or more different devices, systems, or combination of systems and/or devices capable or emitting electromagnetic energy at the one or more first frequencies located within a region of the electromagnetic spectrum invisible to the human eye. In one or more embodiments, the plurality of emitters 120 can include one or more types of incandescent lamps, fluorescent lamps, light emitting diodes (“LEDs”), or the like. In one or more specific embodiments, the plurality of emitters 120 can include one or more types of IR LEDs, UVA LEDs, or combinations thereof. The plurality of emitters 120 can include, but are not limited to LEDs having one or more physical geometries, including but not limited to, round, square, rectangular or combinations thereof. The plurality of emitters 120 can include any number, combination, or type of LEDs, including but not limited to surface mount LEDs, through-hole mount LEDs, or the like. In one or more embodiments, LEDs can be used to provide all or a portion of the plurality of emitters 120. The plurality of emitters 120 can include LEDs having an operating voltage of from about 0.5V to about 100V; about 1V to about 70V; about 1.3V to about 50V; about 1.3V to about 10V; or about 0.5V to about 5V. In one or more specific embodiments, the plurality of emitters 120 can be a plurality of surface mount, rectangular, 0.5 mm LEDs operating at a voltage of from about 0.5V to about 5V.

In one or more embodiments, all or a portion of the receivers 124 (i.e. the unpowered portion of the plurality of emitters 120) can function as photodetectors when illuminated with incident electromagnetic energy at or near the one or more first wavelengths. In one or more specific embodiments, all or a portion of the receivers 124, can generate an output signal directly or indirectly proportionate to the quantity and/or intensity of incident electromagnetic energy at the one or more first frequencies. In one or more specific embodiments, all or a portion of the receivers 124, can generate an output voltage directly or indirectly proportional to the quantity and/or intensity of incident electromagnetic energy at or near the one or more first frequencies. In one or more embodiments, the increase in incident electromagnetic energy on the one or more receivers 124 can provide a reliable indication and/or location of a reflective object disposed proximate the first layer 105.

All or a portion of the plurality of emitters 120 can be coupled to one or more controllers 160. In one or more embodiments, the controller 160 can transmit data, power, communication signals, administrative signals or any combination thereof to all or a portion of the plurality of emitters 120 via one or more communications channels 150. In one or more embodiments, the controller 160 can receive data, power, communication signals, administrative signals or any combination thereof from all or a portion of the plurality of emitters 120 via one or more communications channels 155. In one or more embodiments, the controller 160 can control the distribution of power from one or more independent devices, such as a reduced-voltage AC or DC power supply, to all or a portion of the plurality of emitters 120.

The controller 160 can group, divide, or otherwise equally or unequally apportion the plurality of emitters 120 into transmitters 122 and receivers 124. The controller 160 can designate all or a portion of the individual emitters forming the plurality of emitters as either transmitters 122 or receivers 124 on a temporary or permanent basis. In one or more embodiments, the controller 160 can permanently designate a first portion of the emitters forming the plurality of emitters 120 as transmitters 122, with the remaining portion designated as receivers 124. In one or more embodiments, the controller 160 can temporarily designate all or a portion of the individual emitters forming the plurality of emitters 120 as either transmitters 122 or receivers 124. In apportioning the plurality of emitters 120 into transmitters 122 and receivers 124, the controller 160 can use any ratio of transmitters to receivers. In one or more embodiments, the ratio of transmitters to receivers (transmitters:receivers) can be about 1:1 or more; about 2:1 or more; about 3:1 or more; about 4:1 or more; about 5:1 or more; about 10:1 or more; about 20:1 or more; or about 25:1 or more.

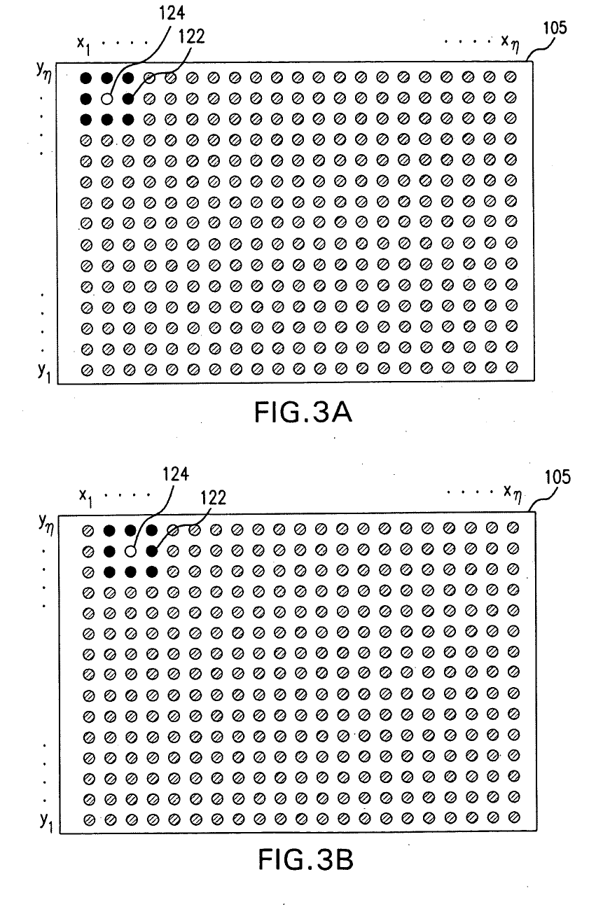

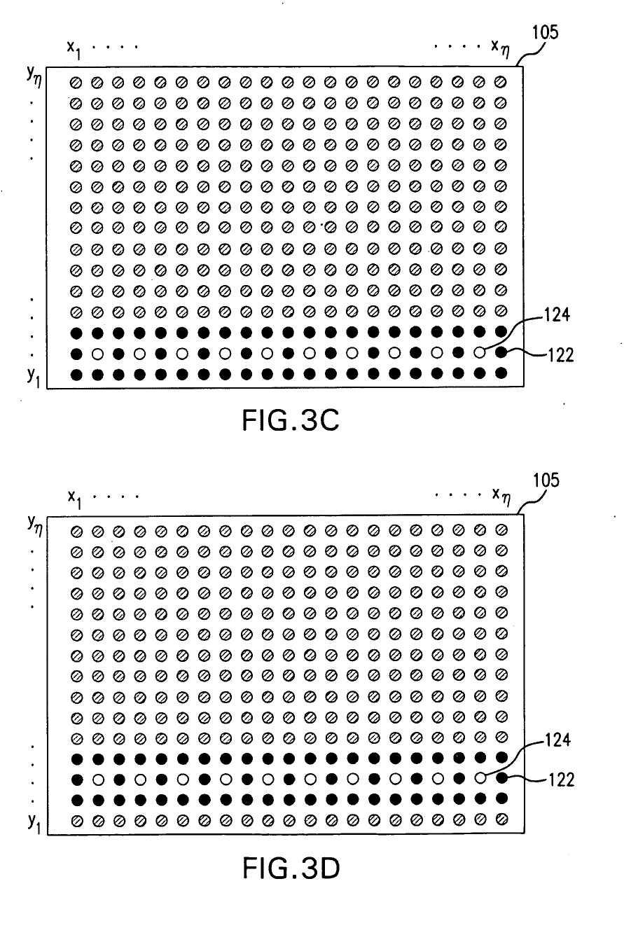

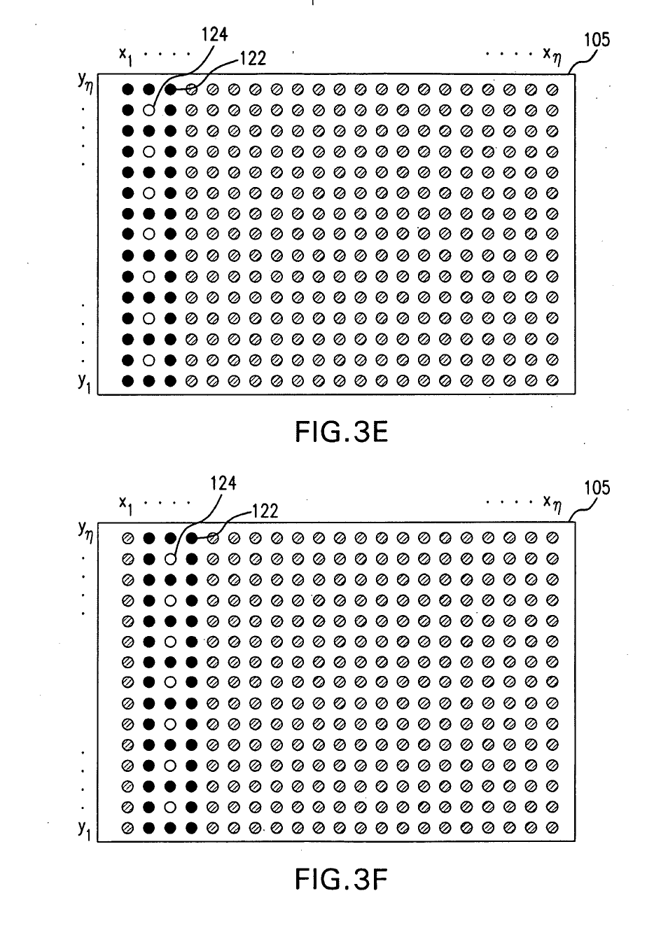

The controller 160 can temporarily designate all or a portion of the individual emitters forming the plurality of emitters 120 as either transmitters 122 or receivers 124. In one or more specific embodiments, the controller 160 can temporarily designate the emitters forming the plurality of emitters 120 as either a transmitter 122 or receiver 124 based upon a predetermined pattern. As discussed in greater detail with regards to FIGS. 3A through 3G below, the controller 160 can allocate or designate one or more transmitters 120 and one or more receivers 124 using a predetermined cyclical and/or sequential pattern, thereby permitting the scanning of all or a portion of the plurality of emitters 120. In one or more embodiments, the scanning of all or a portion of the plurality of emitters 120 using a predetermined cyclical or sequential pattern can detect and/or locate one or more sources of reflected electromagnetic energy disposed proximate the first layer 105.

After designating each emitter forming the plurality of emitters 120 as either a transmitter 122 or a receiver 124, the controller 160 can simultaneously or sequentially apply power to all or a portion of the transmitters 122. As power is applied to the transmitters 122, the controller can simultaneously or sequentially read one or more signals provided from each of the designated receivers 124. In one or more embodiments, the controller 160 can randomly designate (i.e. designate transmitters and receivers in the absence of a pattern) each emitter forming the plurality of emitters 120 as either a transmitter 122 or a receiver 124. In one or more embodiments, the controller 160 can temporarily designate each emitter forming the plurality of emitters 120 as either a transmitter 122 or a receiver 124. In one or more embodiments, the controller 160 can designate each emitter forming the plurality of emitters 120 as either a transmitter 122 or a receiver 124 based upon an algorithm, pre-determined assignment plan, pre-determined assignment pattern, or combinations thereof. In one or more specific embodiments, the controller 160 can temporarily designate each emitter forming the plurality of emitters 120 as either a transmitter 122 or a receiver 124 based upon a pre-determined assignment patterns.

FIGS. 3A through 3G depict various exemplary, temporary, assignment patterns for all or a portion of the plurality of emitters 120. FIGS. 3A and 3B depict a temporary assignment pattern of nine emitters forming a 3×3 matrix of emitters occupying positions (x₁, yₙ) to (x₃, yₙ₋₂). As depicted in FIG. 3A, an exemplary pattern of eight emitters can form a ‘perimeter’ of transmitters 122 about a single receiver 124. FIG. 3B depicts a potential subsequent scan where the assignment pattern of nine emitters has been incremented by one position along the x-axis of the first layer 105 to occupy positions (x₂, yₙ) to (x₄, yₙ₋₂). Subsequent scans can continue to raster the 3×3 matrix pattern along the x-axis. After completing one horizontal scan, the pattern can de-increment by one position along the y-axis of the first layer 105. Such a scan pattern can be repeatedly incremented along the x-axis and de-incremented along the y-axis until all or a portion of the first layer 105 has been scanned. After scanning the entire first layer 105, the 3×3 matrix pattern can be repeated beginning with the 3×3 matrix of emitters in the (x₁, yₙ) to (x₃, yₙ₋₂) positions as described in detail above.

FIGS. 3C and 3D depict another temporary assignment pattern using horizontal rows of emitters 122 and receivers 124. In one or more embodiments, for the first scan, the first row (y₁) of emitters forming the first layer 105 can be transmitters 122; the second row (y₂) of emitters can be an alternating pattern of transmitters 122 and receivers 124; and the third row (y₃) of emitters can be transmitters 122. For the second scan, the pattern can be incremented by one position along the y-axis such that the first row (y₁) of emitters is “off”; the second row (y₂) of emitters can be transmitters 122, the third row (y₃) of emitters can be an alternating pattern of transmitters 122 and receivers 124; and the fourth row (y₄) of emitters can be transmitters 122. Subsequent scans can continue to raster the 3-line horizontal pattern. Such a scan pattern can be repeatedly incremented along the y-axis until all or a portion of the first layer 105 has been scanned. After scanning the entire first layer 105, the 3-line horizontal scan pattern can be repeated beginning with the emitters in the first three horizontal rows (y₁, y₂, y₃) as described in detail above.

FIGS. 3E and 3F depict yet another temporary assignment pattern using vertical rows of emitters 122 and receivers 124. In one or more embodiments, for the first scan, the first column (x₁) of emitters can be transmitters 122; the second column (x₂) of emitters can be an alternating pattern of transmitters 122 and receivers 124; and the third column (x₃) of emitters can be transmitters 122. For the second scan, the pattern can be incremented by one position along the x-axis such that the first column (x₁) of emitters is “off”; the second column (x₂) of emitters can be transmitters 122, the third column (x₃) of emitters can be an alternating pattern of transmitters 122 and receivers 124; and the fourth column (x₄) of emitters can be transmitters 122. Subsequent scans can continue to raster the 3-line vertical pattern. Such a scan pattern can be repeatedly incremented along the x-axis until all or a portion of the first layer 105 has been scanned. After scanning the entire first layer 105, the 3-line vertical scan pattern can be repeated beginning with the emitters in the first three columns (x₁, x₂, x₃) as described in detail above.

It should be readily apparent to one of ordinary skill in the art that the assignment patterns depicted in FIGS. 3A to 3G are non-limiting examples of illustrative assignment patterns and other equally efficacious assignment patterns can be readily substituted to provide equivalent results. Such equivalent assignment patterns are included within the scope of this disclosure.

In one or more embodiments; power can be allocated, switched, applied, or otherwise distributed by the controller 160 to all or a portion of the transmitters 122 thereby stimulating the emission of electromagnetic energy at one or more first wavelengths. In one or more embodiments, the controller 160 can withhold or otherwise halt the flow of power to all or a portion of the receivers 124 thereby permitting the receivers 124 to function as photodetectors, generating a voltage signal based upon the quantity, intensity, and/or duration of electromagnetic energy at one or more first wavelengths incident thereupon.

The process of assigning individual emitters as transmitters 122 and/or receivers 124, scanning the receivers 124 to detect voltage signals therefrom, and reassigning individual emitters based upon a predetermined assignment pattern can be repeated by the controller 160 until all of the emitters forming the plurality of emitters 120 have been assigned as either a transmitter 122 or a receiver 124 for at least one scan. The cycle time required for the controller 160 to designate every emitter forming all or a portion of the plurality of emitters 120 as both a transmitter 122 and a receiver 124 for a minimum of one scan can depend upon numerous factors including, but not limited to, the scan rate of the controller 160, the total number of emitters in communication with the controller 160, the total number of emitters within the display 100, and/or the relative proportion of transmitters 122 to receivers 124. In one or more embodiments, the cycle time can be variable. In one or more embodiments, the scan time, i.e., In one or more embodiments, the cycle time can be fixed, having a minimum time of about 1/1000 sec.; about 1/500 sec.; about 1/200 sec.; about 1/100 sec.; about 1/50 sec.; about 1/30 sec.; or about 1/10 sec.

As used herein the term “scan” can refer to the time required for the controller 160 to designate one or more transmitters 122 and one or more receivers 124; plus the time required by the controller 160 to power the one or more transmitters 122; plus the time required by the controller 160 to receive one or more signals from the one or more receivers 124. For example, referring back to exemplary FIGS. 3A and 3B, the scan time (t_{scan}) would be the time required for the controller 160 to assign the eight transmitters 122 and one receiver 124 plus the time required to simultaneously or sequentially power the eight transmitters 122 plus the time required to receive a voltage signal generated by the one or more receivers 124.

As used herein the term “cycle” can refer to the time required for the controller 160 to designate every emitter forming the plurality of emitters 120 as either a transmitter or receiver. Referring back to the exemplary first layer depicted in FIGS. 3A and 3B, the time required to complete one “cycle” would be the time required for the controller to complete one scan times the total number of scans required to assign every emitter forming the plurality of emitters 120 as either a transmitter 122 or receiver 124. Thus, for the non-limiting, exemplary, first layer 105 depicted in FIGS. 3A and 3B, the cycle time would be (t_{scan}) times the number of discrete horizontal scans (xₙ-3) times the number of discrete vertical scans (yₙ-3).

The controller 160 can include any system, device, or combination of systems and/or devices suitable for directly or indirectly inducing, directing, or controlling the flow of power to the transmitters 122 and for receiving voltage signals from the receivers 124. In one or more embodiments, the controller 160 can include, but is not limited to a chipset disposed in, on, or about the display 100. In one or more embodiments, the controller 160 can include one or more interfaces 170. The one or more interfaces 170 can include one or more output channels 175 permitting the controller to communicate with another device, and/or one or more input channels 180 permitting another device to communicate with the controller 160. In one or more embodiments, the one or more interfaces 170 can include one or more communication ports, each having one or more output channels 175, and/or one or more input channels 180. In one or more embodiments, the interface 170 can include, but is not limited to, one or more industry standard communications ports including, but not limited to any current or future version of the universal serial bus (“USB”) protocol, any current or future version of the IEEE 1394 (“Firewire”) protocol, DE15 VGA, any current or future version of the high-definition multimedia interface (“HDMI”) protocol, any multiple thereof, or any combination thereof.

The second layer 130 can be disposed proximate the first layer 105, and located or otherwise disposed between a user 190 and the first layer 105. In one or more embodiments, the second layer 130 can provide a surface on which one or more images visible to the human eye can be directly or indirectly generated, projected, and/or displayed. In one or more embodiments, the electromagnetic energy generated by the all or a portion of the transmitters 122 can be partially or completely transmissible through the second layer 130. The second layer 130 can include, but is not limited to one or more display technologies such as, a liquid crystal display (“LCD”), a plasma display, a penetron display, or the like. In one or more specific embodiments, the device 100 can be a computer display, and the second layer 130 can be an LCD screen for the display of data or other information provided by the computer via an HDMI port disposed in, on, or about the one or more interfaces 170.

Referring to FIG. 2, when in operation the controller 160 can apply or otherwise supply power sequentially or simultaneously to all or a portion of the transmitters 122. In one or more embodiments, power can be applied to cause the discharge, generation, emission, or radiation of electromagnetic energy 135 at the one or more first wavelengths. In one or more embodiments, all or a portion of the electromagnetic energy 135 emitted by the first layer 105 can strike, impact, or otherwise fall incident upon the second layer 130. All or a portion of the electromagnetic energy 135 incident upon the second layer 130 can partially or completely penetrate the second layer 130. In one or more specific embodiments, the second layer 130 can be one or more materials or substances partially or completely transmissive to the electromagnetic energy 135 at the one or more first wavelengths. In one or more embodiments, the second layer 130 can reflect very little or no electromagnetic energy 135 at or near the one or more first wavelengths back to the first layer 105.

In one or more embodiments, the interface 170, controller 160, first layer 105 and second layer 130 can be disposed in, on, or about an enclosure 210. In one or more embodiments, the enclosure 210 can be impervious or otherwise resistant and/or retardant to the electromagnetic energy 135 at the one or more first wavelengths emitted by the one or more transmitters 122. In one or more embodiments, the enclosure 210 can be a material partially or completely transmissive to the electromagnetic energy 135 emitted by the one or more transmitters 122.

In one or more embodiments, the user 190 can interact with the display 100 by disposing a reflective object 192 proximate the second layer 130. The reflective object 192 can be an animate object, such as a finger, or an inanimate object, such as a stylus, pointer, or the like. When the user 190 disposes the reflective object 192 proximate the second layer 130, a portion of the electromagnetic energy 135 striking, impacting, or otherwise falling incident upon the second layer 130 can be reflected from the reflective object 192. The reflected electromagnetic energy 195 can be at or near the one or more first frequencies (i.e. the phase shift experienced by all or a portion of the reflected electromagnetic energy 195 can be sufficiently small such that all or a portion of the incident electromagnetic energy 135 is reflected at one or more wavelengths at or near the one or more incident first wavelengths). All or a portion of the reflected electromagnetic energy 195 can return to the first layer 105, falling incident upon all or a portion of the plurality of emitters 120. In one or more embodiments, all or a portion of the reflected electromagnetic energy can fall incident upon the individual emitters forming the one or more receivers 124.

In one or more embodiments, all or a portion of the receivers 124 can act as photodetectors, generating one or more signals proximate the reflective object 192, proportionate to the incident reflected electromagnetic energy 195. Since the reflective object 192 can cause all or a portion of the reflected electromagnetic energy 195, the location of the receiver 124 generating a voltage signal can provide an indication of the location of the reflective object 192 with respect to the first layer 105 and/or second layer 130. In one or more embodiments, the one or more voltage signals generated by the receivers 124 can be transmitted to the controller 160 via the one or more communications channels 155. In one or more embodiments, the controller 160 can transmit the location of the reflective object 192 to one or more external devices (not depicted, in FIG. 2) via the interface 170. In one or more embodiments, the one or more external devices can include, but are not limited to a personal computer or the like. In one or more specific embodiments, the one or more external devices can include a personal computer executing one or more software routines awaiting user 190 input, for example acknowledgement of an on-screen dialog box by the user 190.

Additionally, the signal provided to the controller 160 can indicate one or more actions desired by the user 190, for example an indication that the user 190 desires to launch a program by touching an icon depicted on the display 100. Interaction between the user 190 and one or more external devices can be initiated by mapping the location of one or more elements depicted on the second layer 130, for example using one or more x-y coordinates. The mapped coordinates can be compared to the location of the reflective object 192 placed proximate the second layer 130 by the user 190. In one or more embodiments, all or a portion of the mapping and comparison between the elements depicted on the second layer 130 and the location of the reflective object 192 can occur within the external device. In one or more embodiments, all or a portion of the mapping and comparison between the elements depicted on the second layer 130 and the location of the reflective object 192 can occur in the controller 160. In one or more embodiments, a portion of the mapping and comparison between the elements depicted on the second layer 130 and the location of the reflective object 192 can occur in the controller 160, while the remaining mapping and comparison between the elements depicted on the second layer 130 and the location of the reflective object 192 can occur in one or more external devices.

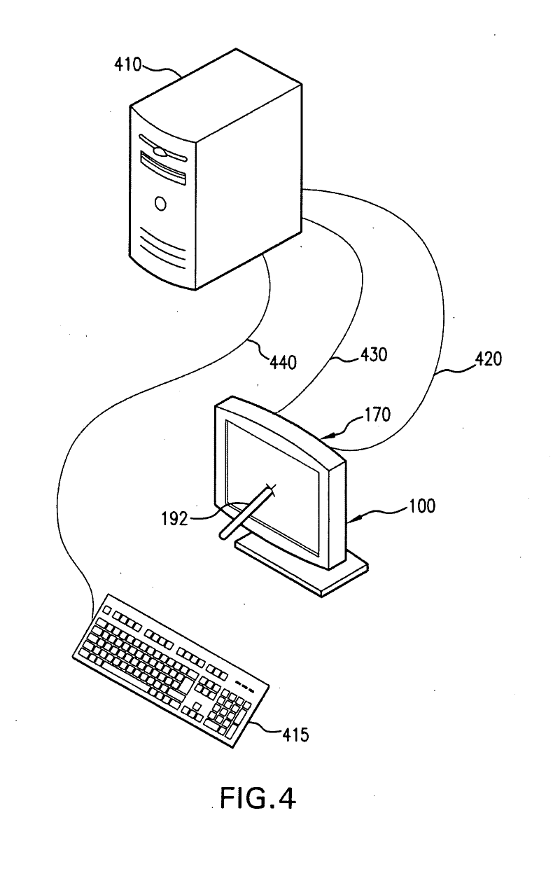

FIG. 4 depicts a system including an exemplary touch-sensitive display, according to one or more embodiments. In one or more embodiments, the system 400 can include one or more touch-sensitive displays 100, central processing units (CPUs) 410, input devices (an exemplary keyboard 415 is depicted in FIG. 4), and one or more conduits (three are shown, 420, 430, and 440). In one or more embodiments, one or more conduits (two are shown, 420 and 430) can interconnect the touch-sensitive display 100 and the CPU 410. In one or more embodiments, the first and second conduits 420 and 430 can provide bidirectional communication between the touch-sensitive display 100 and the CPU 410. In one or more embodiments, although not shown in FIG. 4, the first and second conduits 420 and 430 can be connected to the interface 170. In one or more specific embodiments, the first conduit 420 can include, but is not limited to, a 15 conductor VGA cable, an HDMI cable, a USB cable, or combinations thereof. In one or more specific embodiments, the second conduit 430 can include, but is not limited to, a USB cable, an IEEE 1394 cable, an HDMI cable, a DG 9 cable, or the like.

In one or more embodiments, one or more software routines can be executed by the CPU 410 resulting in the display of data and/or images in, on, or about the second layer 130. In one or more specific embodiments, the second layer 130 of the display 100 can be an LCD display capable of displaying the software generated data and/or image transmitted from the CPU 410 via the one or more conduits 420. The software can be any software requiring user interaction including, but not limited to games, productivity related software, business related software, and the like.

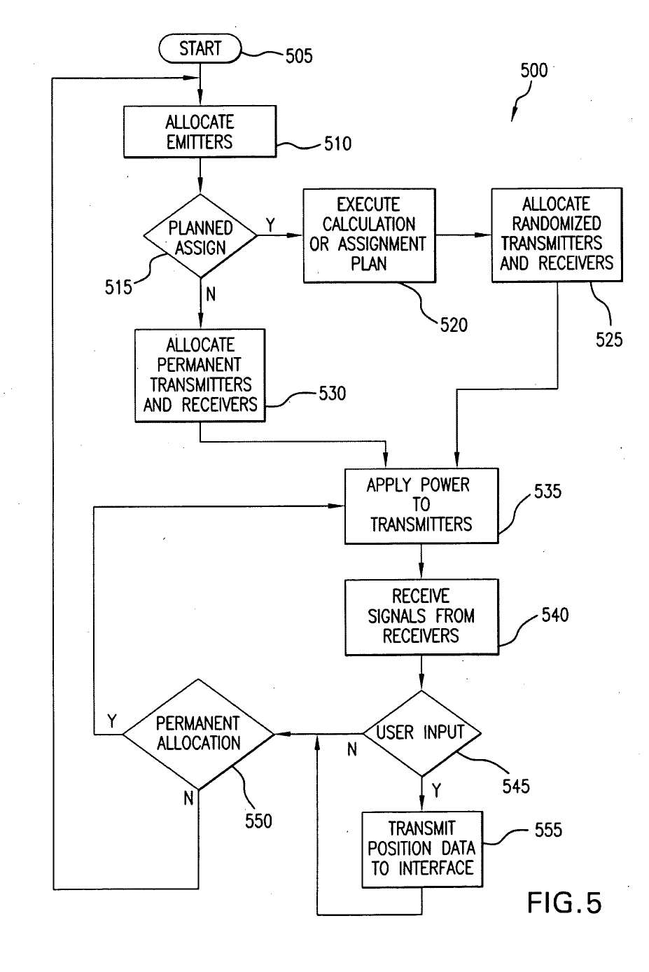

FIG. 5 depicts an illustrative logic flow diagram for controlling the exemplary touch-sensitive display 100, in accordance with one or more embodiments. In one or more embodiments, all or a portion of the logic depicted in FIG. 5 can be executed partially or completely within the controller 160, by the CPU 410, or in equal or unequal portions divided therebetween. For simplicity and ease of description, the logic will hereinafter be described as though executed by an exemplary controller 160, with the understanding that one or more equally effective alternative embodiments can include apportioning the execution of all or a portion of the logic in one or more external controllers, for example, one or more video controllers within the CPU 410.

In step 510, the controller 160 can designate all or a portion of the emitters forming the plurality of emitters 120 as either transmitters 122 or receivers 124 according to one or more allocation plans. The one or more allocation plans can include, but are not limited to, a temporary assignment plan, a permanent assignment plan, or any combination thereof.

In step 515, the controller 160 can determine whether a temporary assignment plan should be used to designate the one or more transmitters 122 and one or more receivers 124. If a temporary plan is indicated, in step 520 the controller 160 can execute logic to allocate the one or more transmitters 122 and one or more receivers 124 based upon the temporary assignment plan. In step 525, the controller 160 can then physically assign, designate, or otherwise allocate the one or more transmitters 122 and the one or more receivers 124. After allocating the one or more transmitters 122 and the one or more receivers 124, the control logic can pass to step 535 where power can be applied to the one or more transmitters 122.

If, in step 515, a temporary assignment plan is not used, in step 530, the controller 160 can permanently allocate the one or more transmitters 122 and the one or more receivers 124 based upon a default allocation plan. In one or more specific embodiments, the default allocation plan can be a permanent assignment plan where the one or more transmitters 122 and the one or more receivers 124 are permanently assigned, designated, or otherwise allocated by the controller 160. After allocating the one or more transmitters 122 and the one or more receivers 124 according to the default assignment plan, the control logic can pass to step 535 where power can be applied to the one or more transmitters 122.

In step 535, the controller 160 can allocate, switch, distribute or otherwise cause the one or more transmitters 122 to receive power. Power can be applied to all or a portion of the transmitters 122 in any manner, including simultaneous, sequential or any combination thereof. After applying power to all or a portion of the transmitters 122 in step 535, the controller 160 can receive one or more signals from the receivers 124 in step 540.

If no user input is detected, i.e. no receivers 124 are generating a voltage signal due to incident electromagnetic energy, and the controller 160 determines in step 550 that a default assignment plan was applied to the plurality of emitters 120, control can be returned to a point where power is applied to the transmitters 122 in step 535. If, in step 550, the controller determines that a temporary assignment plan was applied to the plurality of emitters 120, the controller can re-allocate the emitters in step 510.

The controller 160, after applying power to the one or more transmitters 122 in step 535 and receiving one or more voltage signals from the one or more receivers 124 in step 540, can determine whether the reflected electromagnetic energy, i.e. user input, was received in step 545. If no user input is detected in step 545 and the controller 160 determines in step 550 that a default assignment plan was applied to the plurality of emitters 120, control can be returned to a point where power is applied to the transmitters 122 in step 535. If, in step 550, the controller determines that a temporary assignment plan was applied to the plurality of emitters 120, the controller can re-allocate the emitters in step 510.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A touch-sensitive display device comprising:
a first layer comprising a plurality of emitters disposed in a grid or matrix,
wherein, a first portion of the emitters emit electromagnetic energy at one or more first wavelengths invisible to the human eye; and,
wherein, a second portion of the emitters absorb incident electromagnetic energy at one or more first wavelengths; and,
wherein, the second portion of the emitters generate a voltage signal proportionate to the incident electromagnetic energy;
a second layer comprising screen for the display of images visible to the human eye,
wherein the one or more first wavelengths are partially or completely transmissible through the second layer; and,
wherein the second layer is disposed between the first layer and a user; and,
wherein all or a portion of the electromagnetic energy at the one or more first wavelengths is reflected from the second layer to the first layer when the user passes one or more objects in front of the second layer.

2. The touch-sensitive display of claim 1, wherein the one or more first wavelengths comprise one or more infrared wavelengths from about 800 nm to about 1,000 nm.

3. The touch-sensitive display of claim 1, wherein the plurality of emitters comprise a plurality of infrared light emitting diodes.

4. The touch-sensitive display of claim 1, wherein the second layer comprises a liquid crystal display, a plasma display, a penetron display, or any combination thereof.

5. The touch-sensitive display of claim 1, wherein the one or more objects comprise, a finger, a stylus, a pointer, an IR emitter, or any combination thereof.

6. A method for providing a touch-sensitive display, comprising:
disposing a plurality of emitters in a grid or matrix, thereby forming a first layer;
dividing the plurality of emitters into a first portion comprising one or more transmitters and a second portion comprising one or more receivers;
disposing a second layer suitable for the display of images visible to the human eye between the first layer and a user;
emitting electromagnetic energy at a first frequency using the first portion of the plurality of emitters,
wherein the electromagnetic energy is invisible to the human eye; and
wherein all or a portion of the electromagnetic energy at the one or more first frequencies is partially or completely transmissible through the second layer; and
wherein no power is applied to the second portion of the plurality of emitters;
passing an object across the second layer,
wherein all or a portion of the electromagnetic energy at the one or more first frequencies transmitted through the second layer is partially or completely reflected by the object; and
measuring the reflected electromagnetic energy using the second portion of the plurality of emitters to generate a voltage signal.

7. The method of claim 6, wherein the emitters comprise IR LEDs, UVA LEDs, or any combination thereof.

8. The method of claim 6, wherein the one or more first wavelengths comprise one or more infrared wavelengths from about 800 nm to about 1,000 nm.

9. The method of claim 6, wherein the second portion of emitters provide a voltage signal proportionate to the quantity of electromagnetic energy incident upon one or more of the second portion of emitters.

10. The method of claim 6, wherein the plurality of emitters comprise a plurality of infrared light emitting diodes.

12. The method of claim 6, wherein the second layer comprises a liquid crystal display, a plasma display, a penetron display, or any combination thereof.

13. The method of claim 6, wherein the one or more objects comprise, a finger, a stylus, a pointer, an IR emitter, or any combination thereof.

14. A touch-sensitive display apparatus, comprising:
a housing comprising an enclosure having at least one side fully or partially open and a first layer and a second layer disposed therein;
wherein the first layer comprises a plurality of infrared light emitting diode emitters,
wherein a first portion of the emitters are powered; and
wherein when powered, the first portion of the emitters emit electro-magnetic energy at an infrared wavelength of from about 800 nm to about 1,000 nm; and,
wherein a second portion of the emitters are unpowered; and
wherein when unpowered, the second portion of the emitters absorb reflected electromagnetic energy at an infrared wavelength of from about 800 nm to about 1,000 nm; and
wherein the second layer forms at least a portion of the open side of the enclosure; and,
wherein the second layer comprises a liquid crystal display for the display of images at one or more second, visible light, wavelengths of from about 300 nm to about 790 nm,
wherein the infrared electromagnetic energy generated by the plurality of emitters is partially or completely transmissible through the liquid crystal display forming the second layer; and,
wherein all or a portion of the infrared electromagnetic energy is reflected from the second layer back to the first layer from one or more objects disposed proximate to the second layer.

15. The apparatus of claim 14, wherein the ratio of the number of emitters in the first portion to the number of detectors in the second portion is a minimum of about four to one (4:1).
